(19) United States
(12) Patent Application Publication
(10) Pub. No.: US 2006/0234617 A1
(43) Pub. Date: Oct. 19, 2006

(54) Power tool accessory identification system

(75) Inventors: Jeffrey Francis, Nottingham, MD (US); Steven J. Phillips, Ellicott City, MD (US); David A. Carrier, Aberdeen, MD (US); Danh T. Trinh, Parkville, MD (US); Andrew E. Seman JR., White Marsh, MD (US); Christopher R. Yahnker, Raleigh, NC (US); Daniele C. Brotto, Baltimore, MD (US); Joshua West, Towson, MD (US); Gregory Rice, Aberdeen, MD (US)

Correspondence Address: HARNESS, DICKEY & PIERCE, P.L.C., P.O. BOX 8910, RESTON, VA, 20195, US

(73) Assignee: Black & Decker Inc.

(21) Appl. No.: 11/388,095

(22) Filed: Mar. 24, 2006

Related U.S. Application Data
(60) Provisional application No. 60/665,087, filed on Mar. 25, 2005.

(51) Int. Cl. A22C 21/00

(52) U.S. Cl. 452/174

(57) ABSTRACT

A power tool accessory identification system includes a power tool which has a motor, an output spindle actuatable by the motor, and a tool holder connected to the spindle and configured to hold an accessory therein. The power tool includes an accessory reader to decoding an identification device on the accessory. In a method of controlling the power tool with an accessory operatively coupled thereto, the accessory is inserted in the tool and a communication interface between the accessory and tool is read. An accessory identification is decoded via an accessory reader of the tool. A tool setting for the power tool is accessed based on the decoded accessory identification.

### PRIORITY STATEMENT

This application claims the benefit under 35 U.S.C. §119(e) to U.S. Provisional Patent Application Ser. No. 60/665,087, filed Mar. 25, 2005 to Jeffrey FRANCIS et al. and entitled “POWER TOOL ACCESSORY IDENTIFICATION SYSTEM, the entire contents of which is hereby incorporated by reference herein.

### BACKGROUND OF THE INVENTION

1. Field of the Invention

Exemplary embodiments of the present invention relate to a power tool configured to identify tool accessories and to a method for controlling a power tool having an accessory coupled thereto.

2. Description of the Related Art

Electrical power tools such as variable speed drills, power screw drivers, circular saws, etc., typically are configured to receive various tool accessories. For example, accessories adapted for a variable speed drill includes drill bits, fastening bits and other cut-out tools. A circular saw includes accessories such as saw blades and abrasives. Each accessory has a given speed or rate at which optimum performance is attained, based on the dimensions and specifications of the given tool accessory.

Generally, power tool speed is selected by a user through manual depression of the trigger switch in the tool. If the power tool has an open-loop motor control circuit, the speed of an output spindle of the tool decrease as the tool is loaded, and current drawn by the motor increase. If a relatively constant output speed is desired, the operator can manually compensate for the reduction in motor speed as the tool is loaded by further retracting the trigger switch. This increases the power applied to the motor. Alternatively, if the power tool has a closed-loop motor control circuit, the control circuit can automatically increase the amount of power supplied to the motor as the output spindle of the tool is loaded, so as to maintain the desired speed.

However, the user (or even the control circuit) generally cannot determine the optimum speed of operation for the accessory. Although in some circumstances the speed ranges of a typical variable speed tool are sufficient to span the operational range of a given tool accessory, the speed may not be the optimum operating speed of the accessory. Thus, desired performance and/or efficiency of the tool accessory may not be achieved when operating the tool.

### SUMMARY OF THE INVENTION

An exemplary embodiment of the present invention is directed to a power tool. The power tool may include a motor, an output spindle actuatable by the motor, and a tool holder connected to the spindle and configured to hold an accessory therein. The power tool includes an accessory reader to decoding an identification device on the accessory.

Another exemplary embodiment of the present invention is directed to a method of controlling a power tool having an accessory operatively coupled thereto. In the method, the accessory is inserted in the tool and a communication interface between the accessory and tool is read. An accessory identification is decoded via an accessory reader of the tool. A tool setting for the power tool may be accessed based on the decoded accessory identification.

### BRIEF DESCRIPTION OF THE DRAWINGS

Exemplary embodiments of the present invention will become more fully understood from the detailed description given herein below and the accompanying drawings, wherein like elements are represented by like reference numerals, which are given by way of illustration only and thus are not limitative of the exemplary embodiments of the present invention.

FIG. 1A is a block diagram illustrating a battery pack and a power tool in accordance with an exemplary embodiment of the present invention.

FIG. 1B is a block diagram illustrating a driver circuit in accordance with an exemplary embodiment of the present invention.

FIG. 2 is a flowchart illustrating an exemplary method of determining a desired speed of a tool accessory.

FIG. 3 is a block diagram illustrating a battery pack and a power tool in accordance with another exemplary embodiment of the present invention.

FIG. 4 is a flowchart illustrating an exemplary method of determining a desired speed of a tool accessory.

FIGS. 5A and 5B are perspective views of a tool accessory (i.e., a saw blade) with an identification system in accordance with an exemplary embodiment of the invention.

FIGS. 6A and 6B illustrate schematic views of an optical encoder in accordance with exemplary embodiments of the invention.

FIG. 7 is a perspective view of a tool accessory with identification marks for decoding by the optical sensors in accordance to an exemplary embodiment of the invention.

FIG. 8A is a flowchart illustrating a process of monitoring sync and encode magnets on a tool accessory in accordance with an exemplary embodiment of the invention.

FIG. 8B is a flowchart illustrating another example method of determining a separation between sync magnet and data magnet pulses.

FIG. 9 is perspective view of a tool (i.e., drill) interfacing with a tool accessory (i.e., cut-out tool) in accordance with an exemplary embodiment of the invention.

### DETAILED DESCRIPTION OF THE EXEMPLARY EMBODIMENTS

As used herein, power tools may be understood as a corded power tool, or a cordless power tool powered by portable power sources such as nickel cadmium (NiCd), nickel metal hydride (NiMH), lead acid and/or lithium-ion (LI-ion) battery packs. Exemplary power tools may include, but are not limited to, drills, high torque impact wrenches, single-handed metal working tools, nailers, hand planers, circular saws, jig saws, variable speed belt sanders, reciprocating saws, two handed drills such as rotary and demolition hammerdrills, routers, cut-off tools, plate joiners, drill presses, table saws, thickness planers, miter saws, metal working tools, chop saws, cut-off machines, bench grinders, etc. Some of these tools are commercially available only in a corded version, but may become cordless. These classifications are not intended to be inclusive of all power tools for which the exemplary embodiments of the present invention are applied, merely illustrative.

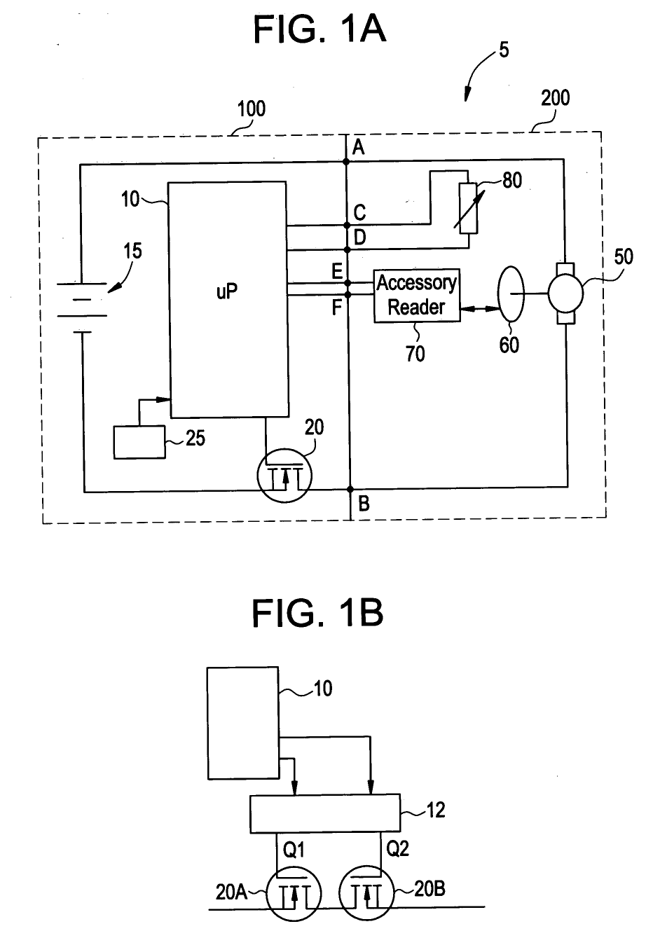

FIG. 1A is a block diagram illustrating components and connections between an exemplary battery pack and an exemplary power tool in accordance with the present invention. FIG. 1A is an embodiment circuit configuration to provide context for more clearly describing the example power tool method and/or circuits.

Referring to FIG. 1A, control circuit 5 represents circuit connections between a battery pack 100 and a tool 200. The battery pack 100 may include at least one (or more) battery cells 15, a microprocessor 10, a semiconductor device 20 and a memory 25. The tool 200 may include a motor 50, a tool accessory 60 interfacing the tool 200, an accessory reader 70 and a variable speed potentiometer 80. It should be appreciated that more than one battery cell 15 may be used and connected in series and/or parallel. Battery pack 100 may be at least one of a lithium ion (LI-ion), a nickel cadmium (NiCd), a nickel metal hydride (NiMH) and a lead-acid battery pack, for example, in terms of the chemistry makeup of individual cells, electrodes and electrolyte of the pack 100. However, other lithium-based chemistries may be used, such as Li-based chemistries employing manganese, cobalt or other oxides, spinel, phosphate and/or combinations of one or more of these constituent components.

In FIG. 1A, six terminals (terminals A-F) connect the battery pack 100 to the tool 200. More or less than six terminals may be employed, depending on the desired information passed there between or parameters monitored by the battery pack 100 and/or tool 200.

The battery pack 100 may include a battery pack microprocessor 10 to identify the tool accessory and to set the appropriate optimum speed of tool 200. The microprocessor 10 may be embodied in hardware or software as a digital microcontroller, an analog circuit, a digital signal processor or by one or more digital integrated circuits (IC) such as application specific integrated circuit (ASIC) under control of a suitable microcontroller, for example.

The pack microprocessor 10 may be powered by current generated between terminals A and B. The current can be clamped or discontinued by the use of a semiconductor device 20, for example. Semiconductor device 20 may be a metal oxide semiconductor field effect transistor (MOSFET), for example, under the control of the pack microprocessor 10, although device 20 could be another type of switchable device. The semiconductor device 20 may control the voltage applied across the motor 50 in accordance with, for example, a duty cycle of a pulse width modulated (PWM) control signal received from pack microprocessor 10. PWM is modulation in which the duration of pulses vary based on characteristics of a modulating signal, as is known.

FIG. 1B is a block diagram illustrating a driver circuit in accordance with an exemplary embodiment of the present invention. Referring to FIG. 1B, driver circuit 12 is provided to control inputs to semiconductor devices 20A and 20B, based on a command signal from microprocessor 10. The semiconductor devices 20A and 20B may be linked through the driver circuit 12. Power connections for charging and discharging current may be represented at terminals A and B.

During discharge, the pack microprocessor 10 may output pulse width modulation (PWM) control signals to drive the driver circuit 12. A pulsing semiconductor (e.g., pulse width modulator) is commonly used in the electronics industry to create an average voltage, or an average voltage that is proportional to the duty cycle. In either case, the semiconductor devices 20A and 20B (shown as a discharge FET Q1 and charge FET Q2) may be switched between ON and OFF states to create the average voltages.

Thus, the driver circuit 12 may shift the PWM output of pack microprocessor 10 so as to drive the gate of semiconductor device 20A, cycling the semiconductor device 20A ON and OFF depending on sensed conditions. The semiconductor device 20B may pass current with only a diode drop in voltage, since semiconductor device 20B is reverse-biased. If lower losses are required, the pack microprocessor 10 outputs a command to the driver circuit 12 which maintains the semiconductor device 20B ON during the PWM action. This may result in a controlled discharge with lower losses through the semiconductor device 20B, for example.

During charge, a reverse logic can be applied. Semiconductor device 20A is reversed-biased with respect to current flow, whereas semiconductor device 20B can control the charge current based on information from the microprocessor 10 via driver circuit 12. The component arrangement that comprises the driver circuit 12 is known in the art and not described herein for purposes of brevity.

The pack microprocessor 10 may be powered by an internal power supply. Battery pack 100 may further include a current sensor (not shown) to sense current and provide a signal to the microprocessor 10. Semiconductor devices 20A and/or 20B may include a pull down resistor to act as a bypass for semiconductor device 20 when power is OFF and the pack 100 is dormant.

The battery pack 100 may include one or more temperature sensors (not shown). The temperature sensor(s) may communicate the temperature inside the battery pack 100 to the pack microprocessor 10 and/or an attached tool 200, for example.

Referring to FIG. 1A, the pack microprocessor 10 may be an 8-bit microprocessor with on-board memory, such as in the form of read-only memory (ROM) for example. The ROM stores identification data of the tool accessory 60. Pack microprocessor 10 may have a configuration different than 8-bits.

The pack microprocessor 10 may also access the memory 25 to read a plurality of values stored in a look-up table therein, which may represent varying speeds for a particular tool accessory 60. The memory 25 is operatively connected to the microprocessor 10. The memory 25 may be any non-volatile memory, such as, but not limited, to EPROM and EEPROM. Memory 25 stores information relating to the battery pack 100, such as, but not limited, type of pack, pack capacity and/or charging process. Similarly, the pack microprocessor 10 may direct information related to a charger (not shown) to be stored in memory 25, such as, but not limited to, number of batteries charged, number of times switch was on or activated (i.e., the number of times a refresh mode was selected), number of times the charging process was delayed to allow cooling of the batteries, etc. Further, the pack microprocessor 10 may designate a string of memory slots or “buckets” for storing related information. A detailed teaching of the use of buckets for storing information is described in U.S. Pat. No. 6,218,806 to Brotto et al., which is hereby incorporated by reference in its entirety.

The pack microprocessor 10 can be responsive to a variable speed potentiometer 80 (which may be a variable resistor, for example) located in the tool 200, when pressure is applied to a trigger on tool 200 for desired speed. The variable speed potentiometer 80 measures the value of resistance so as to identify the amount of desired speed. The pack microprocessor 10 may be programmable so as to read a trigger position from analog signals at terminals C and D. Based on the trigger position data, the pack microprocessor 10 varies the pulse width modulation (PWM) duty cycle of semiconductor device 20 to obtain the desired speed of the motor 50.

A tool accessory 60 may interface with power tool 200. The tool accessory 60 may be embodied as one or more drill bits, fastening bits and/or other cut-out tools for a variable speed drill, for example, and/or saw blades and abrasives for a circular saw, for example. It should be understood that many other types of accessories 60 are usable with the power tool 200. Indirectly, the accessory 60 may be connected to a gear train of the motor 50 to produce rotation and torque.

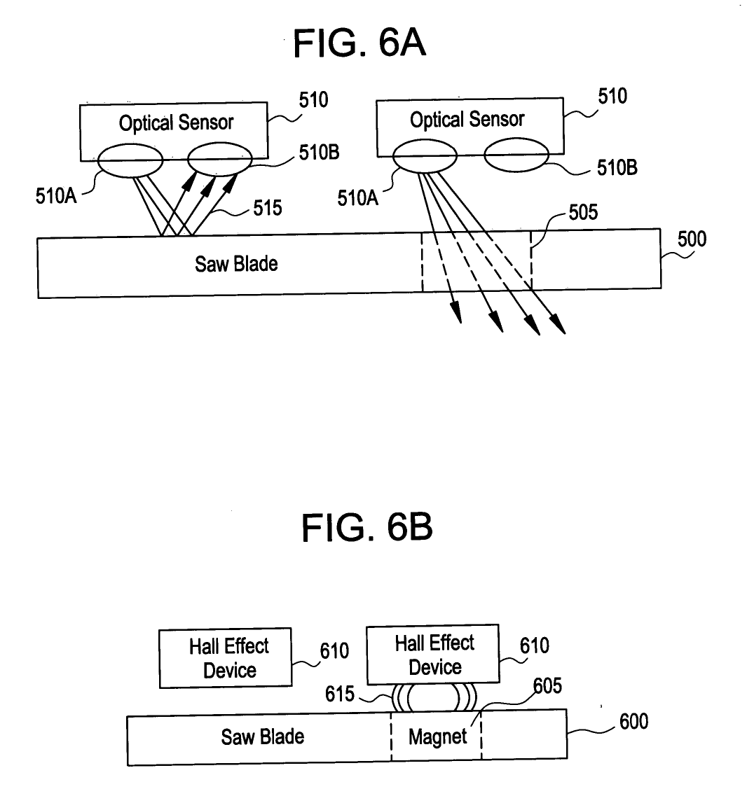

Accessory 60 may include an identification device (hole 505 in FIG. 6A and 605 in FIG. 6B) that includes information that is recognized by the pack microprocessor 10. The information includes information regarding various parameters of the accessory 60, such as, but not limited to, type, make, model number, size, optimum speed, temperature limits, voltage limits, current limits, serial identification numbers, hardware revision numbers, software revision numbers, fault conditions, or other detailed information that is attributed to accessory 60. The identification device 505/605 may be embodied as an optical bar code, an antenna, holes, magnetic connection points, and/or a plurality of optical connection points such as a light source, for example. It should be appreciated that other identification devices for tool accessory 60 may be employed.

The identification device 505/605 may be decoded by an accessory sensor 70. The sensor 70 may be embodied as a radio frequency sensor, a bar-code reader, an emitter sensor, an optical sensor, (such as a light reader), and/or a magnetic sensor such as a hall-effect sensor or a magneto-resistive sensor. Each sensor may include a respective modulator/demodulator. Other sensors may be implemented, so long as the sensor decodes the information stored in the identification device 505/605. The sensor 70 may be immune to vibration caused in the tool 200 and may provide electrical isolation for other tool components, for example.

Further, known modulation techniques may be used to modulate the data on the tool accessory 60, such as pulse width modulation (PWM), pulse code modulation, amplitude modulation and frequency modulation (in the case of analog signals) and/or, multiple frequency modulation (MFM), run length limited (RLL), on-off keying (OOK), phase-shift-keying (PSK), multiple-phase-shift-keying (MPSK) and frequency-shift-keying (FSK), (in the case of digital signals).

For a RF communications interface, any one of the above modulation schemes may be used to ensure reliable data. The tool accessory 60 and sensor 70 may each have an RF connection point such as an antenna, instead of a magnetic connection point. In an optical communication interface, any one of the above modulation schemes may also be used, with the tool accessory 60 and sensor 70 each having an optical connection point such as a light source and/or optical receiver, as opposed to a magnetic connection point.

The data communication interface between the accessory sensor 70 and the pack microprocessor 10 may illustratively be a two wire system via terminals E and F. However, other interfaces can be used, such as, by way of example and not of limitation, a single wire system, a three-wire system, a synchronous system, and/or an asynchronous system. The interface may illustratively be hardwired or wireless. Further, the data could be multiplexed or modulated over other lines, such as the power lines connected via terminals A and B.

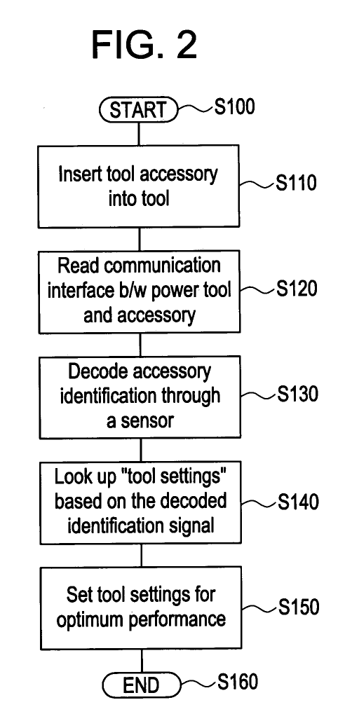

FIG. 2 is a flowchart illustrating a method of determining a desired speed when a tool accessory is inserted into a power tool, in accordance with an exemplary embodiment of the invention. Referring to FIG. 2, a function of setting the desired speed of the power tool is invoked (S100), and a determination is made as to whether a tool accessory 60 (e.g., drill bits, fastening bits, cut-out tools, blades, abrasives, etc.) is inserted (S110) into the tool 200. The communication interface between the tool accessory 60 and power tool 200 is read (S120), i.e., the pack microprocessor 10 determines if there is a data link between the tool accessory 60 and power tool 200. An accessory sensor 70 can then recognize and identify the accessory 60 by reading (S130) the identification device 505/605 on the tool accessory 60.

Once the identification device 505/605 on the accessory 60 has been identified by sensor 70, tool settings are determined (S140) based on the decoded identification signal. The settings may be implemented by the pack microprocessor 10. These settings are accessible from a suitable look-up table stored in the pack microprocessor 10, for example. Hence, the tool settings may be implemented (S150) to obtain the desired performance of the tool accessory 60.

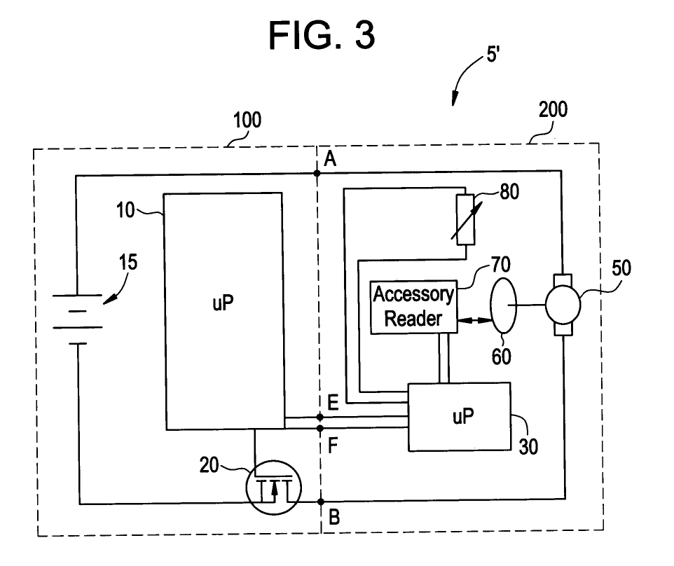

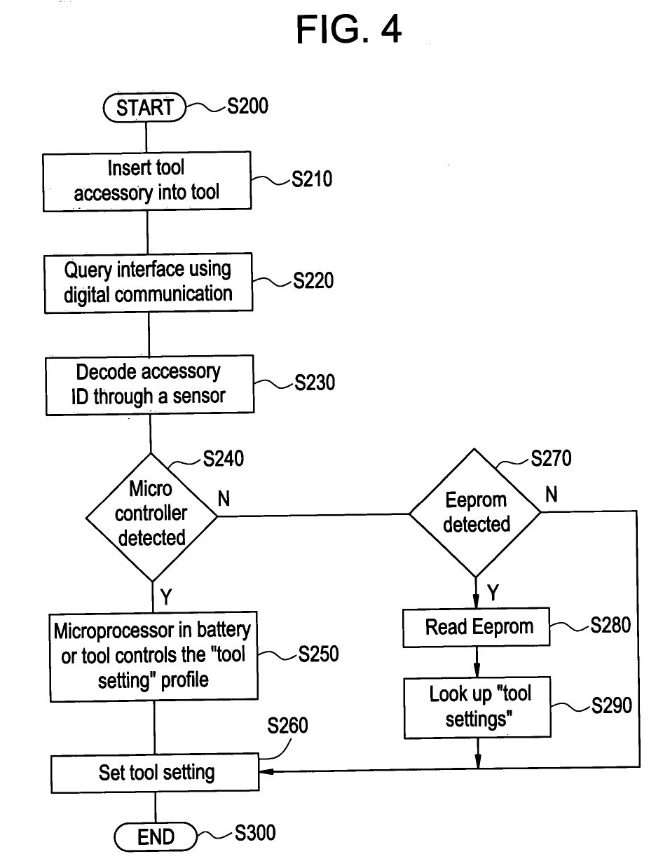

FIG. 3 is a block diagram illustrating components and connections between a battery pack and a power tool in accordance with another exemplary embodiment of the present invention. FIG. 3 is merely an exemplary circuit configuration provided as context for more clearly describing the various methods, circuits and/or devices in accordance with the exemplary embodiments. Elements in common with that shown in FIG. 1A are identified with like reference numerals.

Referring to FIG. 3 and as represented by a control circuit 5′, a tool microprocessor 30 in tool 200 may interface with the accessory sensor 70, which in turn may communicate with pack microprocessor 10. The tool microprocessor 30 may detect identification data of the accessory 60 by reading the accessory sensor 70 and sending data signals to pack microprocessor 10 to control parameters such as speed of the motor 50.

The tool microprocessor 30 and pack microprocessor 10 may read and send data using, for example, digital communication. One of the pack microprocessor 10 and the tool microprocessor 30 may be designated as a “smart” controller that controls and/or sets the desired parameter, such as the speed to operate the tool accessory 60. If the tool microprocessor 30 fails to detect that battery pack 100 has a smart microprocessor 10, then tool microprocessor 30 checks to determine if battery pack 100 has a memory 25 (such as EEPROM) in which information about the accessory 60 is stored. If the battery pack 100 has a memory 25, the tool microprocessor 30 sets the desired and/or optimum speed of the power tool 200 based on the information stored in memory 25.

The data communication interface between the tool microprocessor 30 and the pack microprocessor 10 may illustratively be a two-wire system over serial data paths via terminals E and F, for example. However, other interfaces can be used, such as, by way of example and not of limitation, a single wire system, a three-wire system, a synchronous system or an asynchronous system. The interface may be a hardwired or wireless interface, for example.

The tool microprocessor 30 may also interface with the variable speed resistor potentiometer 80 to provide a user with the capability of adjusting speed. The tool microprocessor 30 may be programmable so as to read a trigger position of a trigger in tool 200 and report the trigger position via serial data paths. Based on the trigger position, the tool microprocessor 30 sends a command to pack microprocessor 10 to vary the PWM duty cycle of semiconductor device 20 so as to achieve the desired speed of motor 50.

FIG. 4 is a flowchart illustrating a method of determining motor speed when a tool accessory is inserted into a power tool, in accordance with the exemplary embodiment of FIG. 3. Referring to FIG. 4, the function of setting the desired speed of the power tool 200 is initiated (S200), with detecting whether a tool accessory is inserted into the tool (S210). For instance, a drill bit or a fastening bit may be fitted into a variable speed drill, and a saw or an abrasive may be fitted into a circular saw. The tool microprocessor 30 determines whether the tool accessory 60 is properly inserted in the power tool 200 with a query to the interface between tool accessory 60 and power tool 200 using digital communication. If the tool accessory 60 is determined as properly inserted, then an accessory sensor 70 may read the accessory identification system on the tool accessory 60 and send the decoded signal to the tool microprocessor 30 (S230).

The tool microprocessor 30 may query the battery pack 100 using digital communications, for example, to determine whether there is a microprocessor in battery 100 (S240). If the microprocessor 30 detects that battery pack 100 has a pack microprocessor 10 (output of S240 is ‘YES’) and determines that the pack microprocessor 10 is a smart controller (S245), then tool microprocessor 30 determines whether pack microprocessor 10 will control the tool settings or whether it will control the tool settings (S250).

At this point, control may be allocated to the selected microprocessor 10 or 30 depending on the determination at S250. Once control is allocated to the proper microprocessor 10 or 30, the tool setting parameters are initialized based on information obtained from the sensor 70, and may be set to the desired setting (S260) to obtain the desired performance of the tool 200.

If the tool microprocessor 30 does not detect that battery pack 100 includes a smart microprocessor 10 (output of S240 is ‘NO’), then tool microprocessor 30 may check to determine if battery pack 100 has a memory 25 (S270), such as an EEPROM, which stores information of the tool accessory 60. If battery pack 100 has a memory (output of S270 is ‘YES’), then the tool microprocessor 30 reads the memory 25 (S280) to access a look-up table (S290) and initialize tool setting parameters (S260) based on the information obtained from the look-up table in memory 25 (S260).

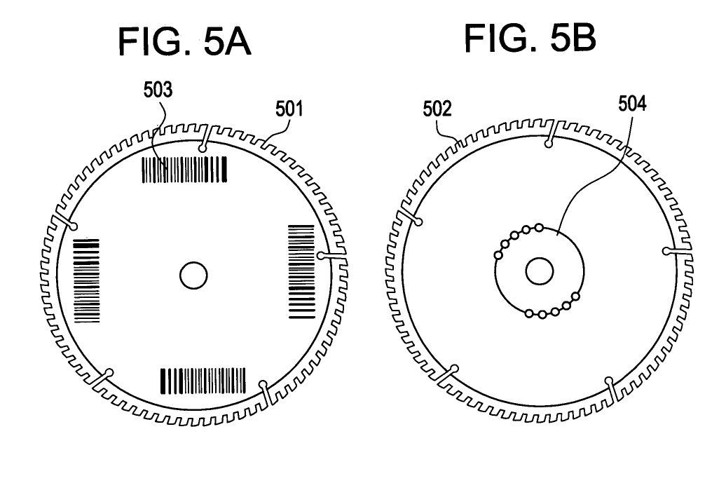

FIG. 5A and FIG. 5B are perspective views of a tool accessory (i.e., a saw blade) having an identification device in accordance with an exemplary embodiment of the present invention. A saw blade 501 is shown in FIG. 5A. Saw blade 501 may be a DEWALT™ Construction Series 20 12-inch blade adapted to engage a conventional circular saw, for example, although the exemplary embodiments are not limited to this example. The saw blade 501 may include a bar code 503 as the identification device for sensor 70 to scan and read. In some implementations, the bar codes 503 may be black and white bars in which the information may be encoded in the widths of the bars. However, it should be appreciated that the bar codes 503 may be array of dots and/or other types of indicia adjacent to lines that store information regarding the tool accessory (saw blade 501 in this example).

The sensor 70 may read the bar code 503 with an optical reader or bar code scanner, for example. The sensor 70 (e.g. an optical reader or bar code scanner) may include a source that emits radiation in a range of wavelengths, a device for scanning the radiation across the bar code, and a detector that receives the reflected radiation. The sensor 70 may decode the information of the saw blade 501 from electrical signals produced by the detector, since the reflectance from the black bars may be significantly different than that from the white bars. Bar code scanning technology is known in the art and will not be described further herein for reasons of brevity.

Another example accessory saw (blade 502) is shown in FIG. 5B. Saw blade 502 may be embodied as a DEWALT™ Construction Series 20 12-inch blade adapted to fit in a circular saw, for example, although may be another type of accessory 60 tool. As an exemplary embodiment, the saw blade 502 may include holes 504 rather than bar codes 503 as the identification device for sensor 70 to read and decode.

FIGS. 6A and 6B illustrate schematic views of an optical sensor in accordance with another exemplary embodiment of the present invention. As shown in FIG. 6A, an optical sensor 510 is illustrated for scanning a tool accessory 500 (e.g., saw blade in this example). The optical sensor 510 may include an emitter 510A and a receiver 510B. The emitter 510A may emit a source of light signals 515 onto the accessory 500 (such as a circular saw blade in one example) and the receiver 510B may receive the light signals 515 for decoding the signals. In an example, the emitter 510A and receiver 510B may be separate components. The optical sensor 510 scans the tool accessory 500 and identifies an identification mark, such as holes 505 (which could correspond to holes 504 in FIG. 5B, for example) on the tool accessory 500 so as to be processed by one of pack microprocessor 10 and/or tool microprocessor 30.

The hole sensing technique may involve the use of an optical source of radiation and a detector that receives the reflected radiation. The optical sensor 510 may decode the information from the electrical signal produced by the detector, since the reflectance from hole 505 will be significantly different than that of the surrounding blade 500 material. The timing of the reflectance changes may allow the optical sensor 510 to decode the pertinent information from the tool accessory (i.e., saw blade 500).

Other hole sensing techniques may use a source of magnetic radiation, and a detector that measures the radiation. The optical sensor 510 may decode the information from the electrical signal produced by the detector since the magnetic signature of the hole may be significantly different than that of the surrounding material, such as a ferrous material.

The optical sensor 510 may produce a magnetic field and be perturbed by the passing saw blade 500. The hole 505, being a non-ferrous material, would produce a detection signal that is substantially differentiated from the surrounding metal saw blade 500 material (e.g., ferrous). Once the blade speed is determined as stable by monitoring a synchronizing signal, the detector signal may be monitored to determine the point at which the optical sensor 510 is transitioning from a ferrous region (solid) on the blade 500 to a non-ferrous region (hole 505) and then back again. As the different signal levels are read, time may also be recorded. The timing of the transition points along with a synchronization signal may allow the optical sensor 510 to determine the relative position and distance of all the holes 505 on the blade 500 which may essentially decode the pertinent information from the tool accessory (blade 402 in FIG. 5B, for example).

FIG. 6B illustrates an optical encoder 610 for scanning tool accessory 600 (e.g., a saw blade). In an example embodiment, the optical encoder 610 may be embodied as a Hall Effect sensor. The optical encoder 610 may employ field transmitters such as Hall Effect sensors 610 disposed at known locations or at a fixed reference frame.

Each Hall Effect sensor 610 may project a field varying in space in a fixed frame of reference. The pattern of variation in space for a given Hall Effect sensor 610 may be different than the pattern of variation for one or more other Hall Effect sensors 610. For example, the Hall Effect sensors 610 may be identical to one another, but disposed at different locations or in different orientations. The field patterns of the Hall Effect sensors 610 may thus be displaced or rotated relative to one another, which may be relative to a fixed frame of reference.

Each Hall Effect sensor 610 may emit a series of pulses to the pack microprocessor 10 or to the tool microprocessor 30. The pulses are representative of the frequency of rotation of the motor 50. The Hall Effect sensors 610 can be driven at different frequencies so that a signal which varies at different frequencies represents the field at the object from different transmitters. Based on the detected parameters of the field from the individual hall effect sensor 610 and the known pattern of variation of the field from each hall effect sensor 610, the given microprocessor 10 or 30 may calculate the position and/or orientation of the magnet(s) 605, and hence the position of the object bearing the magnet(s) 605, in the fixed frame of reference of the hall effect sensor 610.

In an alternative embodiment, a plurality of Hall Effect sensors 610 may be disposed at various locations and/or orientations in the fixed frame of reference. The location and/or orientation may be deduced from signals representing the parameter of the field prevailing at the various magnets 605. In a further example embodiment, the decoding technique may include detecting the presence and/or location of holes 505 (in the tool accessory of FIG. 6A, as well as the presence and/or location of magnets 605 on the tool accessory 600 of FIG. 6B. As a further example, the magnet 620 may be removed and the remaining hole 605 may serve the same purpose as the magnet.

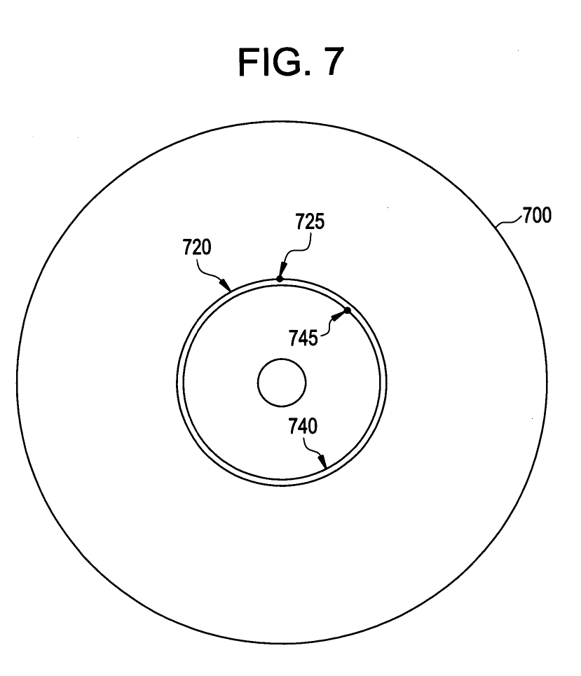

FIG. 7 is a tool accessory with identification marks to be decoded by the optical and/or magnetic sensors, in accordance to an exemplary embodiment of the present invention. Referring to FIG. 7, the tool accessory 700 may include at least two radii. The radii may represent a sync radius 720 and an data radius 740. The sync radius 720 may have a larger diameter relative to the data radius 740. The sync radius 720 may act as a base timing reference for the data radius 740.

The data radius 740 (which may be surrounded by the sync radius 720) may contain information including, but not necessarily limited to type, make, model number, size, optimum speed, temperature limits, voltage limits, current limits, serial identification numbers, hardware revision numbers, software revision numbers, fault conditions, and/or any other detailed information regarding the tool accessory 700. A single radius 700 or 740 may be used to obtain the information of the tool accessory 700. Alternatively, more than two radii may be used to obtain the accessory 700 information.

The tool accessory 700 may include at least one magnet (725 and/or 745) placed “x” degrees apart on each radius, where x is any positive integer value. For example, a sync magnet 725 may be the “zero” point (base reference) while an encode magnet 745 may be placed x degrees apart. With the determination of the location of each magnet 725, 745, the pack microprocessor 10 or tool microprocessor 30 may identify the tool accessory 700 to the power tool 200 by the number of degrees the magnets 725, 745 are separated.

Additional information may be added by adding more magnets 725, 745 in the same radius path, or by adding additional magnets 725, 745 at different radius paths. In another example, the magnets 725, 745 may be replaced by holes and/or other marks so that a sensor such as a Hall Effect sensor 610 may decode the holes magnetic codes. It should further be understood that holes, magnets and/or marks may be used in any combination.

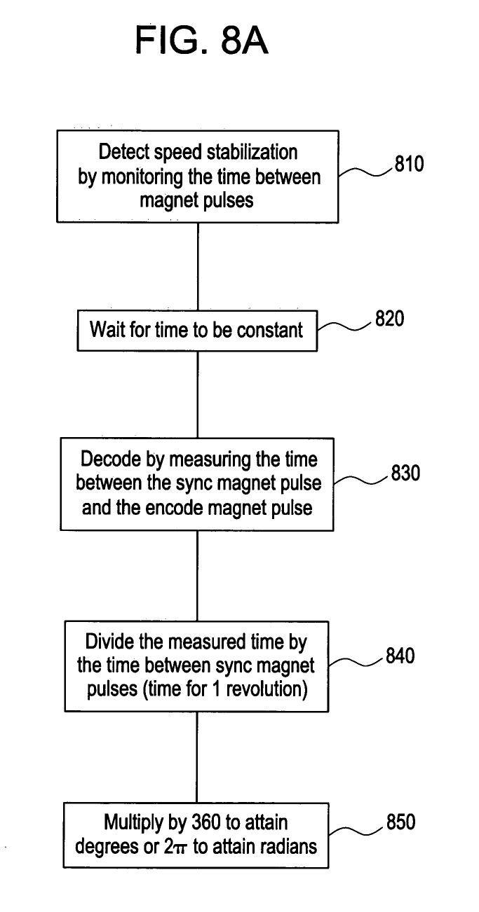

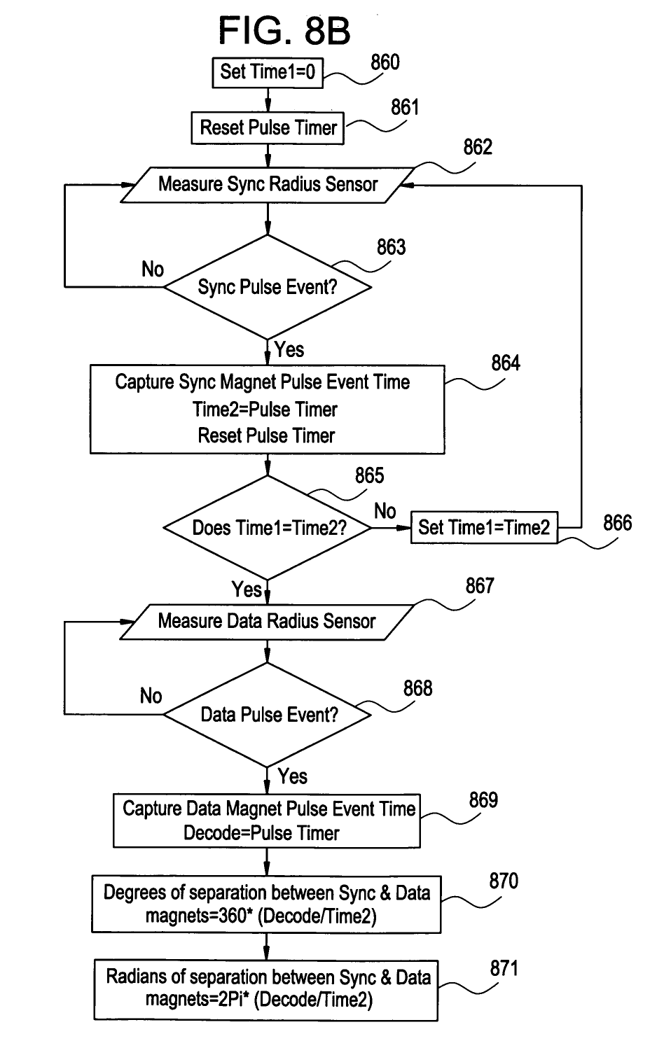

FIG. 8A is a flowchart illustrating a process of monitoring the sync and encode magnets of a tool accessory, in accordance with an exemplary embodiment of the present invention. The flowchart illustrates an exemplary method for determining the separation between pulses of the sync magnet 725 and encode magnet 745.

The pack microprocessor 10 or tool microprocessor 30 may initially detect accessory speed stabilization by monitoring the time between sync radius magnet pulses (S810). Once the speed is stabilized, the given microprocessor 10/30 waits for the time to be constant (S820) to determine a base reference point so that decoding can commence. Decoding may be performed by measuring the time between the sync radius magnet 725 pulse and the data radius magnet 745 pulse (S830). The time may be divided by the time between the sync radius magnet 725 pulse (time for one revolution) (S840). This data may be multiplied by 360 to convert to degrees or by 2π to convert to radians (S850). Accordingly, the calculated magnet location (which can be stored) data may be used to obtain information of the tool accessory.

FIG. 8B is a flowchart illustrating another exemplary method for determining the separation between the sync and data magnet 725, 745 pulses. The calculation of the separation of the sync and data magnets 725, 745 can be processed by one of the pack microprocessor 10 and/or the tool microprocessor 30 to obtain information of the tool accessory.

Initially, a variable Time1 is initialized at zero (S860). Before a time measurement can be performed, a pulse timer is reset to zero (S861). Next, a loop is executed (e.g., reading the sync radius sensor 720) until there is a sync pulse event (S862 and S863). Once an event has occurred, a variable Time2 is set to the elapsed time and the pulse timer is reset to zero (S864).

At this point, the current sync magnet 725 pulse separation time is compared with the previous time of the sync pulse event to determine if the tool accessory speed has stabilized (S865). If the two times (Time1 and Time2) are not close enough in time, (e.g., current sync magnet pulse and previous time sync pulse) stabilization has not been reached and the value of variable Time2 is shifted to Time1 (S866). In an example, Time 1=Time 2 satisfies this threshold. Then, control is returned to S862 until stabilization is achieved. However, if stabilization has been reached and Time1 and Time2 are close enough (S865), stabilization has been reached and control is passed to the data pulse event loop (S867 and S868).

The loop operations at 5867 and 5868 continue until there is a data pulse event (output of S868 is ‘YES’). Next, the pulse timer value representing the difference in time between the sync and data magnets 725, 745 is stored in memory 25 to obtain a Decode variable (S869). Then, the angle in degrees of difference between the two magnets 725, 745 is multiplied by 360 times the Decode value, divided by Time2 (S870) (e.g., radians of separation between sync and data magnets=360×(Decode variable/Time2)). Alternatively, the angle in radians may be 2π times Decode value divided by Time2 (S871) (e.g., radians of separation between sync and data magnets=2π×(Decode variable/Time2)). Accordingly, the calculated data may be used to obtain information of the tool accessory.

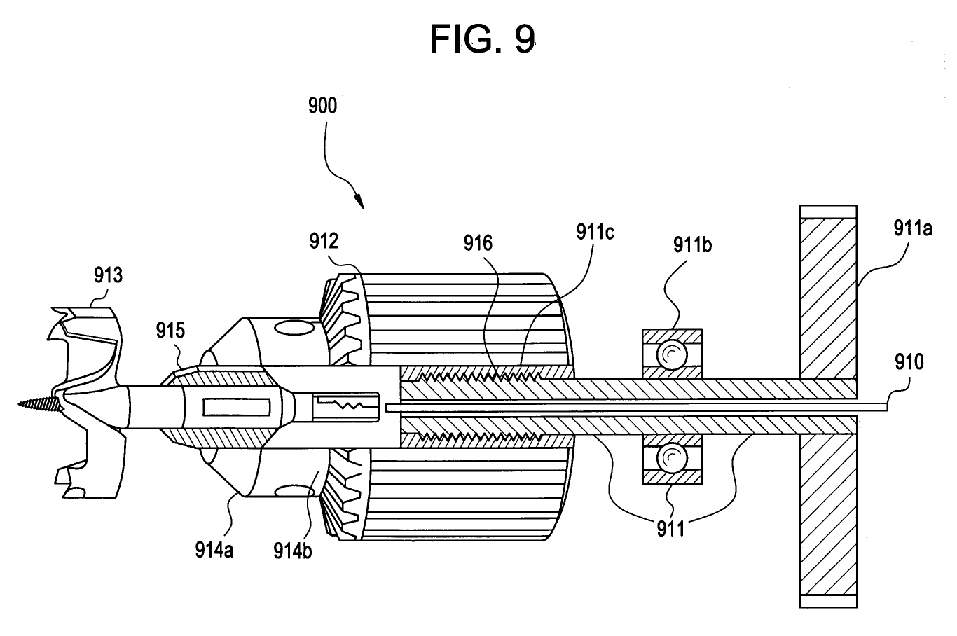

FIG. 9 illustrates an exemplary embodiment of a tool (i.e., drill) interfacing with a tool accessory (i.e., cut-out tool). FIG. 9 in this example illustrates the gearing and chuck of a tool interfacing a tool accessory. Referring to FIG. 9, the tool 900 includes a spur gear output shaft 911 of a tool transmission, a tool chuck 912 that threads onto a threaded end of the transmission output shaft 911, and a tool accessory 913 that is inserted into and retained by chuck jaws 915. Part of the chuck image is cut away to show the relationship of the accessory 913 to a tip of the output shaft all in the center of the chuck 912. Output shaft 911 may have a hollow core so that an insulated electrical core conductor 910 may be inserted.

The tool accessory 913 includes (resistor 914), which may have a given value which represents an identification, embedded in its core at an end that is inserted into the chuck 912. One end 914A of the resistor 914 may be electrically connected to the metal shank of the tool accessory 913, and the other end 914B may be electrically isolated from the shank of accessory 913 but exposed at the tip of the accessory 913 so as to be electrically connected to the electrical core conductor 910 in the center of the transmission output shaft 911. As assembled, the accessory 913 is inserted into the chuck 912, and the chuck jaws 915 are tightened down on the shank of tool accessory 913.

To determine the resistance value of ID resistor 914, an electrical path exists starting at any point (911a, 911b, 911c) on the exterior of output shaft 911. The electrical path is through the output shaft 911 and a threaded interface 916 of the output shaft 911 and chuck 912 (also indicated as 91 1c). The electrical path continues through the chuck 912 to the chuck jaws 915 and then to the accessory 913 clamped in the chuck jaws 915.

The electrical path is created through the accessory 913 to one end of the ID resistor 914 embedded in the accessory 913, continuing through the ID resistor 914 and engaged with the electrical core conductor 910 of the transmission output shaft 911. The core conductor 910 may extend through the output shaft 911 and out the back of the output shaft 911. By passing a known current through the ID resistor 914 and reading the voltage across the resistor 914, the resistance value of the ID resistor 914 can be determined using Ohms Law calculations (R=E/I). There are numerous methods of determining resistance values as known in the art. As such a detailed description will not be described herein for reasons of brevity.

The exemplary embodiments of the present invention being thus described, it will be obvious that the same may be varied in many ways. Such variations are not to be regarded as departure from the spirit and scope of the exemplary embodiments of the present invention, and all such modifications as would be obvious to one skilled in the art are intended to be included within the scope of the following claims.

What is claimed is:

1. A power tool, comprising:
a motor,
an output spindle actuatable by the motor,
a tool holder connected to the spindle and configured to hold an accessory therein, and
an accessory reader for decoding an identification on the accessory.

2. The power tool of claim 1, wherein
the accessory reader is one of a radio frequency sensor, a bar-code reader, an emitter sensor, an optical sensor and a magnetic sensor, and
wherein the identification is embodied as a resistor or resistor pair.

3. The power tool of claim 2, wherein the optical sensor is a light reader.

4. The power tool of claim 2, wherein the magnetic sensor is a hall effect sensor or a magneto-resistor sensor.

5. The power tool of claim 1, wherein the identification device includes information related to parameters of the accessory.

6. The power tool of claim 5, wherein the information includes one or more of a type, a make, a mode number, a size, an optimum speed, temperature limits, voltage limits, current limits, serial identification numbers, hardware revisions, software revisions, fault conditions, or other detailed information related to the accessory.

7. The power tool of claim 1, wherein the identification device is one of an optical bar code, an antenna, one or more holes in the accessory, magnetic connection points and a plurality of optical connection points.

8. The power tool of claim 1, further comprising a battery pack removably attachable to the power tool for supplying power to the tool motor:

9. The power tool of claim 8, wherein the battery pack includes
a plurality of battery cells,
a microprocessor for identifying and controlling the accessory, the microprocessor including memory for storing information relating to the battery pack; and
a semiconductor device for controlling the voltage across the motor.

10. The power tool according to claim 9, wherein the memory includes one or more of ROM or non-volatile memory including EEPROM or flash memory.

11. The power tool of claim 9, wherein the information stored in the memory is at least one of a number of battery cells charged, a number of times a switch was on or activated, a number of times a refresh mode was selected, and a number of times a charging process was delayed to allow cooling of the battery cells.

12. The power tool of claim 1, further comprising a tool microprocessor.

13. The power tool of claim 12, wherein the tool microprocessor communicates with a microprocessor in the battery pack.

14. A method of controlling a power tool having an accessory operatively coupled thereto comprising:
inserting the accessory into the power tool;
reading a communication interface between the accessory and the power tool;
decoding an accessory identification via an accessory reader of the power tool;
accessing tool settings for the power tool based on the decoded accessory identification.

15. The method of claim 14, further comprising detecting a microprocessor in the power tool or a battery pack configured to power the power tool.

16. The method of claim 15, further comprising controlling the tool settings with one of the microprocessors in the power tool or battery pack.

17. The method of claim 16, wherein accessing tool settings includes accessing one or more of a type of accessory, make, mode number, size, an optimum speed, temperature limits, voltage limits, current limits, serial identification numbers, hardware revisions, software revisions, fault conditions and other information related to the one of the accessory or tool

18. The method of claim 14, further comprising detecting a memory in a battery pack that is removably attached to the tool for accessing a look-up table for tool settings.

19. The method of claim 14, further comprising monitoring a sync magnet and an encode magnet on the accessory to obtain information of the tool accessory.

20. The method of claim 19, wherein monitoring further includes:
detecting a speed stabilization by determining a time between magnet pulses;
waiting for time to be constant;
measuring the time between the sync magnet pulses and the encoded magnet pulses;
dividing the measured time by a time between the sync magnet pulses; and
multiplying by 360 to convert measured time to degrees.
